(19) United States
(12) Patent Application Publication
(10) Pub. No.: US 2011/0052400 A1
(43) Pub. Date: Mar. 3, 2011

(54) Horizontal axis wind turbine (HAWT)

(76) Inventor: Sarbuland Khan, Los Angeles, CA (US)

(21) Appl. No.: 12/584,038

(22) Filed: Aug. 31, 2009

(51) Int. Cl. F03D 1/06

(52) U.S. Cl. 416/223 R

(57) ABSTRACT

A horizontal axis wind turbine (HAWT 10) that preferably consists of at least two blades 12. The HAWT (10) is designed to operate against wind speeds ranging from 5 mph to 35 mph (2.2 m/s to 15.65 m/s) and with a blade diameter of at least 3 feet (0.91 meters). Each blade 12 is divided sequentially and longitudinally into a root section (28) that extends from the blade center line (20), an inboard section (30) and an outboard section (32) that terminates at the tip of the blade (12).

### TECHNICAL FIELD

The invention generally pertains to the field of wind turbines and more particularly to a to horizontal axis wind turbine (HAWT).

### BACKGROUND ART

A study of contemporary windmill blades indicates that the design of most blades is based on aircraft wings having a twist. The cross-sectional designs of the windmill blades closely resemble that of aircraft wings, with some blades simply reversed in one plane, thereby resulting in a greater camber on the lower surface of the airfoil profile rather than on the upper surface as with aircraft wings and propellers. Furthermore, windmill blades typically have a very high aspect ratio and taper to the tip, a combination that leads to significantly reduced wind capture. Typically, blade diameters of 15 to 20 feet (4.6 to 6.1 meters) are required to power an average home, thus making it difficult to install a windmill in residential areas, particularly due to strict city ordinances that limit the maximum wind turbine diameter within home installations. For example, in the UK the limit is one meter in diameter within urban areas of the country.

Another common denominator of contemporary blades is that they utilize Bernoulli's principle only. Consequently, with at least a century of development, the state of art has more or less reached a peak in efficiency, as measured by the power coefficient. An increase of only a minimal percentage of the existing efficiency is now considered significant.

A search of the prior art did not disclose any literature or patents that read directly on the claims of the instant invention however, the following U.S. patents are considered related:

| PATENT NO. | INVENTOR | ISSUED |
|---|---|---|
| 6,116,856 | Karadgy et al | 12 Sep. 2000 |
| 6,068,446 | Tangler et al | 30 May 2000 |
| 5,562,420 | Tangler et al | 8 Oct. 1996 |
| 5,474,425 | Lawlor | 12 Dec. 1995 |
| 5,417,548 | Tangler et al | 23 May 1995 |
| 2,269,287 | Roberts | 6 Jan. 1942 |
| 2,101,535 | Engdahl | 7 Dec. 1937 |
| 1,995,193 | Stilphen | 19 Mar. 1935 |

U.S. Pat. No. 6,116,856 issued to Karadgy et al discloses a bi-directional, asymmetrical fan blade having a twist. The airfoil profiles of these blades are ‘S’ shaped and are typically utilized for low Reynolds number operation.

U.S. Pat. Nos. 6,068,446, 5,562,420 and 5,417,548 issued to Tangier et al address the roughness problem associated with wind blades. The solution to this problem is by the use of three current families of airfoil profiles, none of which resemble those of the instant application.

U.S. Pat. No. 5,474,425 issued to Lawlor discloses a wind turbine rotor blade having a horizontal axis that is self-regulating. The blade is designed by employing defined NREL inboard, midspan and outboard airfoil profiles. The profiles interpolate between the defined profiles and from the latter to the root and the tip of the blades. This patent addresses self-regulating, stall-regulated blades and leading edge soiling, and the blade utilizes different families of contemporary profiles. The patent does not address the blade's wind capture or low wind velocity operation.

U.S. Pat. No. 2,269,287 issued to Roberts discloses fan blade profiles having a sharp leading edge and a blunt trailing edge. The blunt trailing edge would create significant drag when rotating at high speeds. This blade's cross-sectional profiles are therefore unsuitable for use in current windmills and substantially differ from those of the instant invention, which utilizes a pointed leading and trailing edge and has several other critical differences.

U.S. Pat. No. 2,101,535 issued to Engdahl discloses a reversible fan propeller with an aircraft wing profile. The blades of the propeller alternate with one blade having a sharp trailing edge followed by a blade with a sharp leading edge. One end of each of these profiles is rounded. A rounded trailing edge on a high velocity blade will create substantial drag. These profiles, when compared to the profiles of the instant invention, including the planform, are significantly different.

U.S. Pat. No. 1,995,193 issued to Stilphen discloses a propeller type fan blade without a twist, which utilizes ‘S’ shaped profiles with a leading edge that is tipped downwards. This profile has considerably different aerodynamic characteristics than those disclosed in the instant application. Airfoils are extremely sensitive to any slight changes in profile, particularly as the profile rises up into higher Reynolds numbers, as required of windmill blades. Fans operate at very low Reynolds numbers. Upon inspection, comparisons of the ‘S’ shaped profiles differ from those disclosed in the instant invention.

Essentially, none of the above-cited patents taken either alone or in combination disclose the novelties of the instant invention in dealing with the problems discussed above. Additionally, none of the patents address the problem of wind capture by the blades or tip drag.

For background purposes and as indicative of the art to which the invention relates, reference may be made to the following remaining patents found in the search:

| PATENT NO. | INVENTOR | ISSUED |
|---|---|---|
| 6,800,956 | Bartlett | 5 Oct. 2004 |
| 6,752,595 | Murakami | 22 Jun. 2004 |
| 6,582,196 | Andersen et al | 24 Jun. 2003 |
| 6,302,652 | Roberts | 16 Oct. 2001 |
| 6,132,181 | McCabe | 17 Oct. 2000 |
| 5,161,953 | Burtis | 10 Nov. 1992 |
| 4,976,587 | Johnston et al | 11 Dec. 1990 |
| 4,969,800 | Parry et al | 13 Nov. 1990 |
| 4,698,011 | Lamalle et al | 6 Oct. 1987 |
| 4,408,958 | Schacle | 12 Oct. 1983 |

### DISCLOSURE OF THE INVENTION

The data presented for the instant invention is empirically based. Formulas are derived and presented for prediction of data, thus providing the range of data presented herein.

The instant invention is comprised of a HAWT, which consists of at least two blades designed to operate against low to medium wind velocities ranging from 5 mph to 35 mph (2.2 m/s to 15.65 m/s) and with blade diameter of at least 3 feet (0.91 meters).

The blade diameter is related to the range of other parameters provided, thus giving a broad scope within the spirit of the instant invention.

The invention discloses a stall-regulated turbine that does not require costly pitching devices. The blade also features a design that provides improved wind capture and therefore can operate at low wind speeds with high performance.

As derived from the Power Table below, the power contained in the wind with respect to the circular surface area, taken from the center of the circular surface area as in the case of wind turbines, is not linear but proportional to the square of the radius that is due to a circle's geometry and the fact that power in this case is proportional to the area involved. For example, at 50% of the radius of the rotor, only 25% of the full power in the wind is available and 50% of the power is contained within the last 29.29% of the rotor diameter. This aspect of geometry is efficiently utilized in the instant invention to produce an improved turbine that has greater efficiency and is viable in low and high wind velocities.

The Power Table utilizes the following formula:

% P=100rₓ² or rₓ=√(% P/100)

where % P=the percentage of wind power at a given velocity incident upon a windmill rotor of radius r=1 (unity) and where rₓ denotes a longitudinal location on the blade.

| rₓ (local radius) | at % of radius (r) | % P (power in wind) |
|---|---|---|
| 0.01r | 1% | 0.01% |
| 0.10r | 10% | 1.00% |
| 0.15r | 15% | 2.25% |
| 0.20r | 20% | 4.00% |
| 0.30r | 30% | 9.00% |
| 0.35r | 35% | 12.25% |
| 0.50r | 50% | 25.00% |
| 0.7071r | 70.71% | 50.00% |
| 1.00r | 100% | 100.00% |

75% of the wind's power is contained within the second half of the blade, from the center of rotation (50% down from the tip of the blade), and 84% of power in the section 60% from the tip of the blade. State of the art blades generally taper in the last 30% of the blade to the tip, which results in a low wind capture rate, as just over 50% of the wind's power is in that region. Additionally, the torque-creating moment increases outward from the center of rotation. Power is the product of torque and blade velocity, which comprise the factors that are taken into account in the three-dimensional designing of the instant invention.

The primary object of the invention is to provide a HAWT having increased wind capture and efficiency. By utilizing the Power Table and other factors, a blade geometry is created with an efficient planform and blade angles designed for low to medium wind speed operation, thus resulting in a reduced blade diameter compared to contemporary blades, for the same power output. The instant invention also has broader efficiency ranges over a larger range of wind speeds compared to contemporary blades, together with a lower rpm. Such improvements provide for additional windmills in a wind farm, thus increasing the wind farm's total output leading to a higher NPV (Net Present Value). Alternatively, using the same blade diameter as those of existing blades in a wind farm would also increase the NPV of the site. The advantage of a broader efficiency band is greater annual energy production. Low rpm compared to that of contemporary windmills considerably reduces the stress forces involved. Reduced blade diameter with greater energy output also facilitates the installation of windmills on homes to provide the full power required by an average urban home.

A further object of the invention is to provide a blade with increased efficiency in very low to medium wind velocities, which range from 5 mph to 35 mph (2.2 m/s to 15.65 m/s).

Another object of the invention is to minimize the airfoil's sensitivity to roughness, which is due to particulate matter, insects and the like. Roughness mainly affects the leading edge of a blade.

Yet another object of the invention is to provide a wide wind-velocity range, self-regulating blade that can be used with, but does not require the use of pitching devices.

The blade of the instant invention takes into account all critical factors, such as the radius to wind power relationship, the decreasing relative wind angles from the base of the blade to the tip and the changing Reynolds numbers between the base and the tip of the blade.

The crucial design parameters of the instant invention, which make it more efficient at low to medium wind speeds, are four fold:
1. the precise design and proportions of the blade planform,
2. the precise designs of the airfoil profiles to provide superior lift to drag ratios,
3. the exact chord angles and their range and
4. the relationship of the blade's c/R ratio in the outboard section to the chord angles and the twist angles for peak performance, as given in the Parameter Relationships Graph.

As it will be apparent to those skilled in the art and in particular aerodynamicists, any alteration to the airfoil profile, blade planform or other aspect of a rotating blade will alter the blade's aerodynamic characteristics and can significantly affect the blade's performance. Thus the instant invention gives exact designs and parametric ranges for optimal performance.

All ranges provided herein take into account several factors, such as the chosen operational wind velocity range for the turbine, weight and type of fabrication material used, length of blades, type of electric generator used and its torque, blade rpm and energy requirements of the end user. These and other factors make it necessary to develop a wide enough range of design parameter options to allow for the necessary adjustments while keeping within the spirit of the instant invention and at the same time maintaining the integrity of the improvements of the instant invention.

### DEFINITIONS AND PARAMETERS

Chord locations are given as a percentage of the ratios of the location of the chord from the center of rotation to the full size of the blade from the center of rotation to the tip or the blade radius, R. Chord size is the ratio of the chord length c, to R, as c/R.

Chord thickness is the ratio of the maximum thickness ^{t}max of the profile, which is the perpendicular distance between the upper and lower profile surfaces where they are parallel and c, as tₘₐₓ/C.
Chord angles are relative to the plane of rotation of the blade.
Twist angle is the difference between the highest and the lowest chord angles of the blade.
The root of the blade is the section extending 25% from the center of rotation (0.25R).
The inboard section follows the root section and is the next 37.5% of the blade (0.375R).
The outboard section follows the inboard section of the instant invention and is the final 37.5% of the blade and includes the tip. In this section the c/R≦0.33. The value of c is averaged in this section and where all chord lengths may be equal. In the preferred embodiment c/R=0.314. θ=the angle between the lower side of a profile anywhere along the blade, for example as shown in FIG. 3 toward the leading edge and the direction of the relative wind.
TSR=tip speed ratio which is the tip speed divided by the wind speed.

The Parameter Chart below lists The Parameter Chart parametric relationships, proportionalities and ranges and gives values for the preferred embodiment. The chart also serves as an example since a range of variations through inter-parameter relationships are implied, as governed by the Parameter Relationships Graph, also given below.

Parameter CHART

| | Chord Locations on FIG. 1 | | | | | | | | | |
|---|---|---|---|---|---|---|---|---|---|---|
| | 1 | 2 | 3 | 4 | 5 | 6 | 7 | 8 | 9 | 10 |
| FIGURES | 3 | 4 | 5 | 6 | 7 | 8 | 9 | 10 | 11 | 12 |
| Chord Location | 6.25 | 12.5 | 18.75 | 25 | 31.25 | 37.5 | 43.75 | 50 | 56.25 | 62.5 |
| % of R | | | | | | | | | | |
| Chord Size(c/R) | 13.30 | 13.50 | 14.40 | 16.24 | 18.58 | 21.40 | 24.50 | 27.39 | 29.48 | 30.67 |
| as a % | | | | | | | | | | |
| Chord Thickness | 29 | 26.30 | 22.20 | 17.7 | 13.64 | 11.31 | 9.79 | 8.67 | 7.69 | 6.88 |
| (tₘₐₓ/c) as a % | | | | | | | | | | |
| Chord Angle | 22.80 to 23 | 27.59 to 28 | 31 | 32 to 32.35 | 31 to 31.26 | 28.47 to 29 | 25 | 21.86 to 22 | 19 to 19.20 | 17 |

| | Chord Locations on FIG. 1 | | | | | |
|---|---|---|---|---|---|---|
| | 11 | 12 | 13 | 14 | 15 | 16 |
| FIGURES | | | | | | |
| Chord Location | 68.75 | 75 | 81.25 | 87.5 | 93.75 | 98.75 |
| % of R | | | | | | |
| Chord Size(c/R) | 31 to 31.18 | 31 to 31.30 | 31 to 31.20 | 30.85 to 31 | 29.51 to 31 | 30.21 to 31 |
| as a % | | | | | | |
| Chord Thickness | 6.30 | 5.74 | 5.17 | 4.73 | 4.45 | 4.30 |
| (tₘₐₓ/c) as a % | | | | | | |
| Chord Angle | 15 to 15.20 | 13.70 to 14 | 12.50 to 13 | 11.60 to 12 | 10.80 to 11 | 10 to 10.30 |

Note:
This chart is given only to serve as an illustration. Other variations of these parameters are implied to accommodate smaller chord sizes using the Parameter Relationships Graph. The values and their interrelationships in this chart apply to the preferred embodiment.

The Parameter Relationships Graph, as shown in FIG. 16 illustrates a chord angle graph z with its +5° to −10° range illustrated by the other two graphs on either side of it. The c/R ratios given apply only to the outboard section of the blade, where in this section c/R≦0.33 (c is averaged for the section) and where all chords may have the same length. (See parameter chart above). The graph illustrates only relationships of specific chord angles to blade radius proportionalities and c/R ratios through blade tip termination points.

Using the Parameter Relationships Graph for the outboard section, the formula for parametric prediction or extrapolation is c/R=0.22/x, where x is the quantity along the x-axis and extends beyond 1.0. The x-axis represents the blade radius relationship to its chord angles and blade tip termination points and not the size of the blade. For instance, when using this formula for outboard average chord size of 7% of blade radius, the x-axis of the graph would extend to 3.14 to give the rest of the chord angles and the blade's peculiar twist angle.

For instance, the graph shows the termination point for the blade at its tip giving the full range of the chord angles, according to any chosen or determined c/R averaged ratio of the outboard section, where c/R≦0.33. The termination point 1, for example, is for the averaged c/R=0.314 for the preferred embodiment. This results in a specific angle range across the length of the blade and its peculiar twist angle. When the averaged c/R ratio for the outboard section is chosen to be less, such as 0.275 or 0.232, then the termination points are at 2 and 3 respectively on the graph, thereby giving the blade additional lower angles and increasing the twist angles accordingly. This is also demonstrated in FIG. 15 where parametric relationships and not size are illustrated, wherein the parametric relationships change as the c/R is changed within ranges given in the instant invention. Note that outboard chord ratios are used for convenience of application and that all other chord lengths and parameters are derived according to the Parameter Chart above in conjunction with the ranges given in the Parameter Relationship Graph, resulting in blade design variations in keeping with the spirit of the instant invention, including variations in the planform of the blade, such as those shown in FIG. 15. The letters X, Y and Z in FIG. 15 indicate examples of the three planform variations of the blade 12, with each having different c/R ratios. From the top down, for each graph on the Parameter Relationships Graph, the c/R ratios are diminishing, additional lower angles are added to the blade and the twist angles are increasing.

For larger blades, load and stress issues can be calculated and applied to data pertaining to the instant invention, in order to arrive at the optimum chord lengths and still maintain the spirit of the instant invention.

### BRIEF DESCRIPTION OF THE DRAWINGS

FIG. 1 is a planform view of the horizontal axis wind turbine (HAWT) showing examples of sixteen chord locations of airfoil profiles, which are equally spaced longitudinally across the three sections of the blade.

FIG. 2 shows a perspective view of the HAWT as shown in FIG. 1.

FIGS. 3 to 12 give examples of ten equally spaced profiles at the first ten chord locations as shown in FIG. 1, from the centerline. FIG. 12 is representative of the remaining six profiles in the locations as shown in FIG. 1, where the chord angles and blade thicknesses continue to reduce. These profiles essentially consist of two basic profile families, as depicted in these figures. The root family of profiles is referred to as family A profiles and the rest as family B profiles, both for Reynolds numbers of at least 1,000,000.

FIG. 13 illustrates an example of an alternate family C profiles, as used in the second embodiment and FIG. 14 is an example of another alternate family D profiles, as used in the third embodiment.

FIG. 15 X, Y and Z are planform views of the HAWT showing how a change in chord size affects the shape of the blade, without affecting the blade's sectional proportionalities.

FIG. 16 is a graph illustrating the parameter relationships of the HAWT.

### BEST MODE FOR CARRYING OUT THE INVENTION

The best mode for carrying out the invention is presented in terms that describe a preferred embodiment of a horizontal axis wind turbine 10 (HAWT 10).

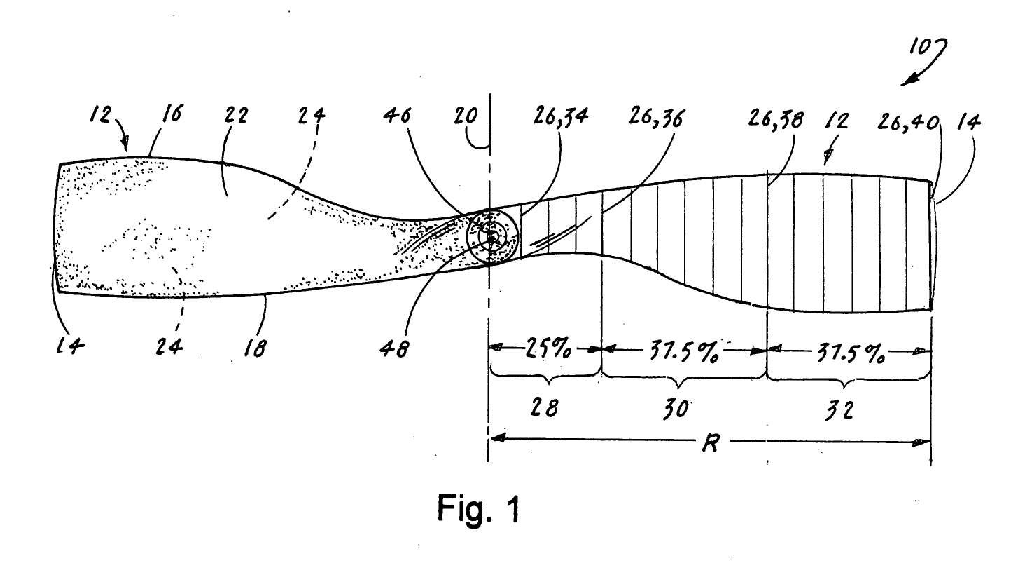

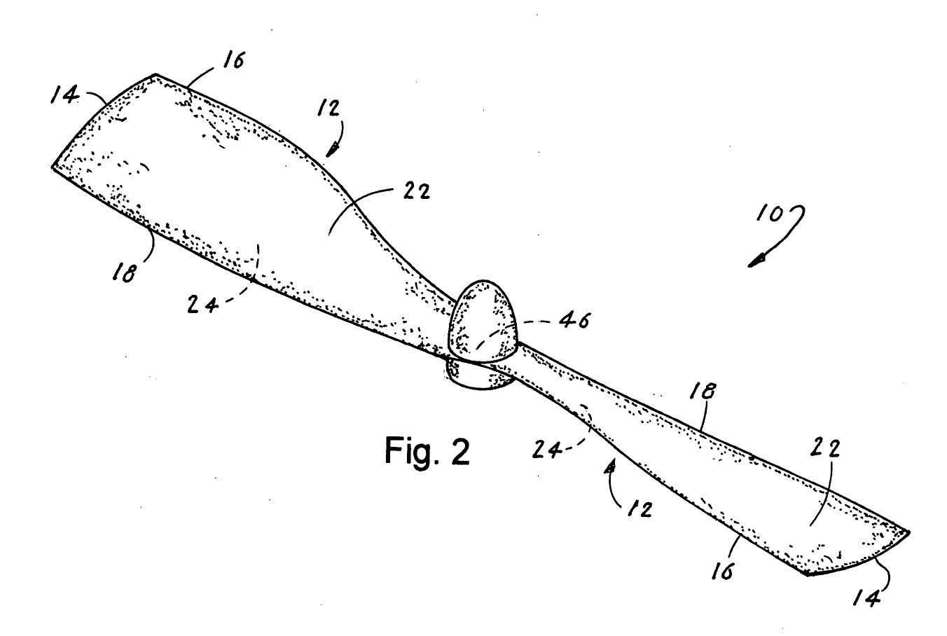

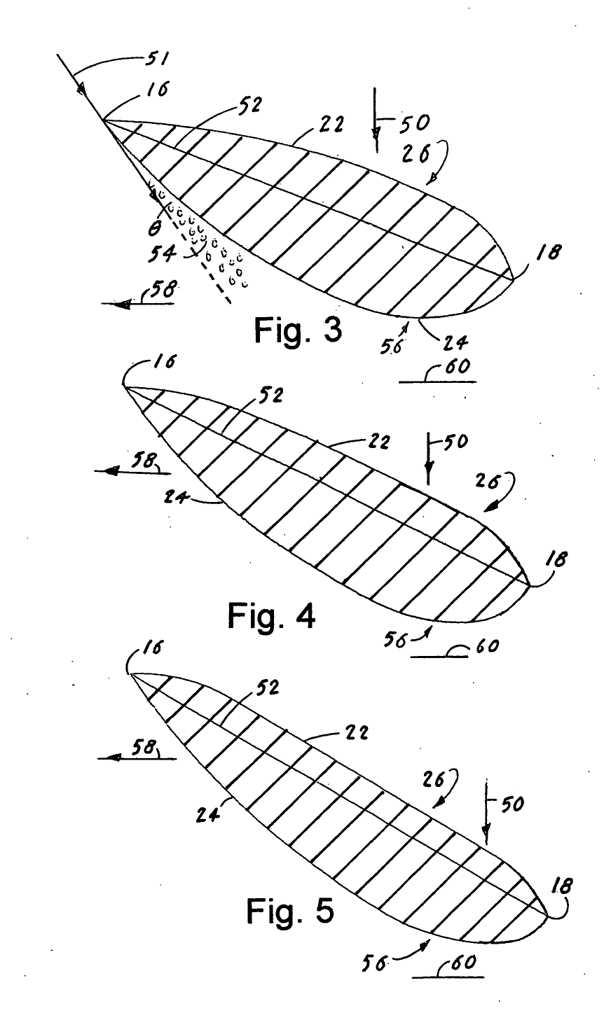

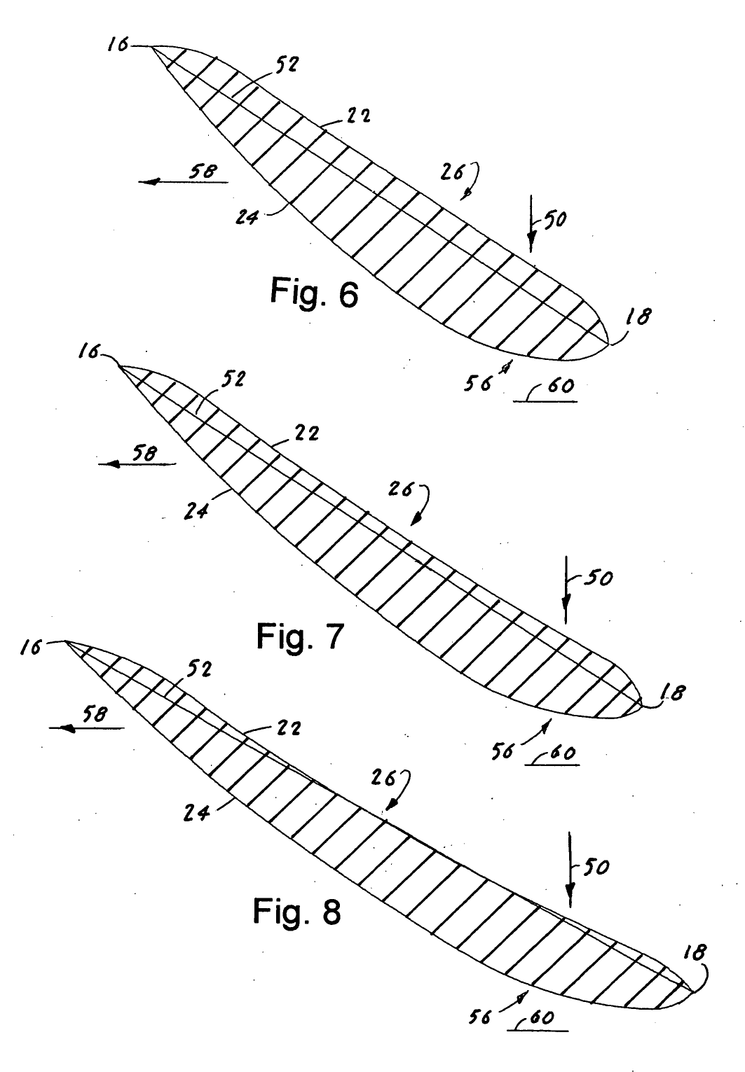

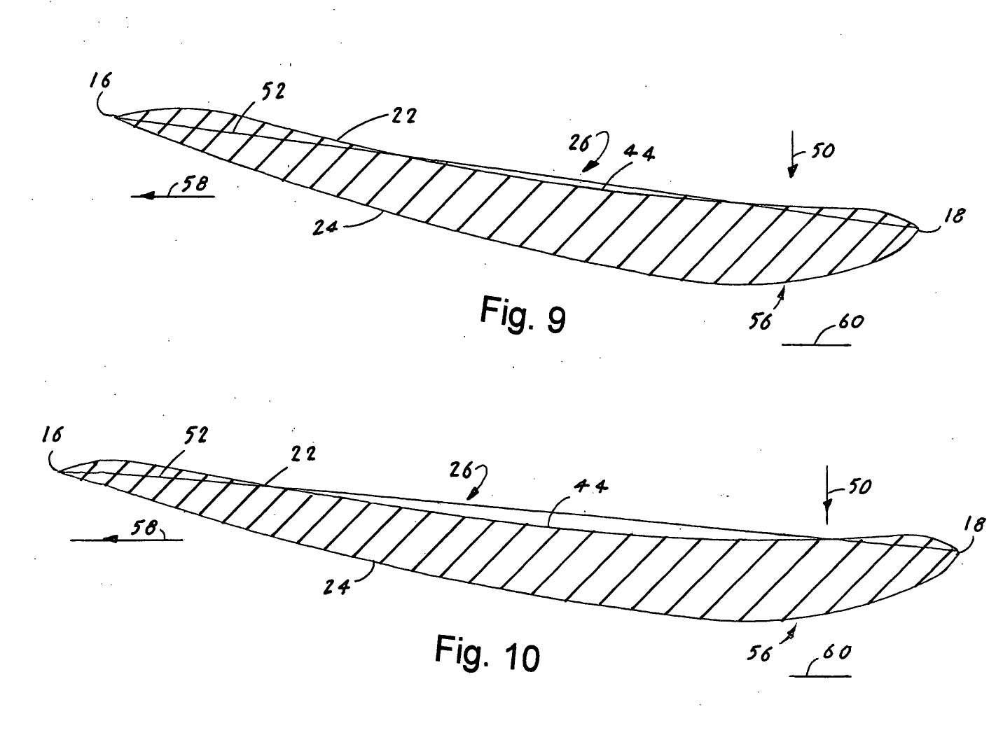

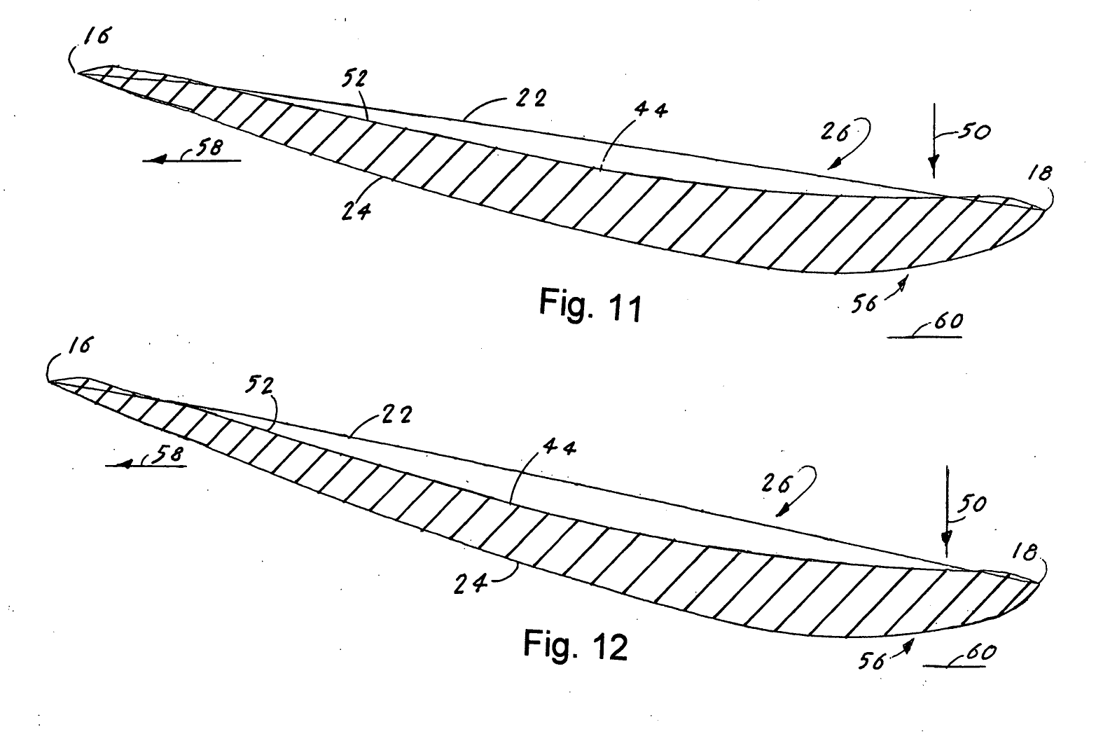

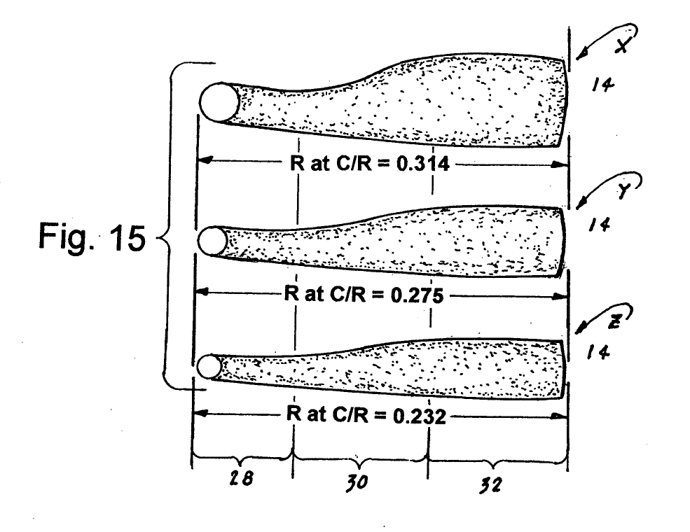

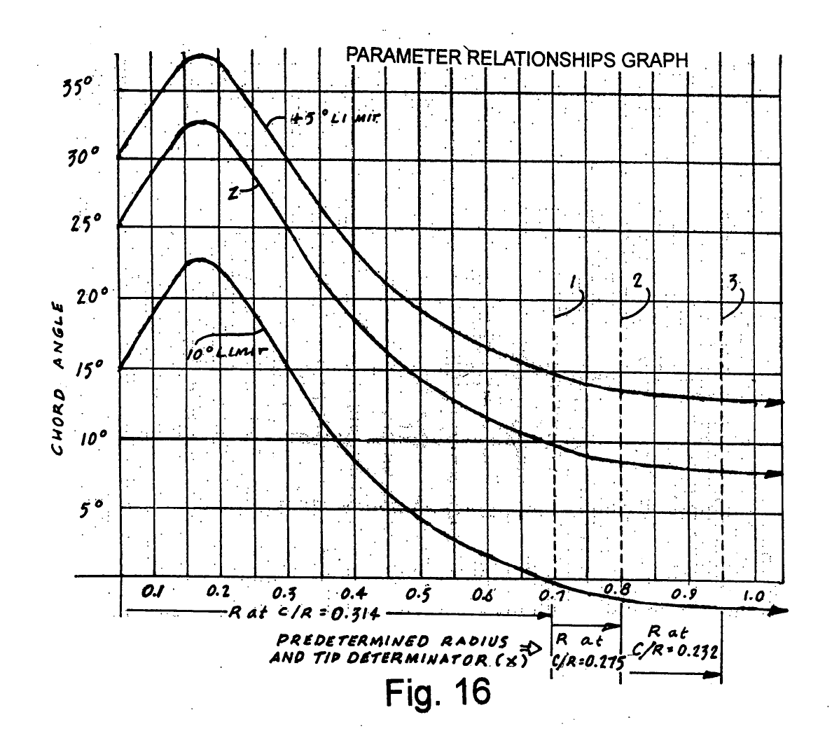

The HAWT 10, as shown in FIGS. 1-16, is comprised of at least two identical blades 12, as shown in FIGS. 1 and 2. The blades are comprised of an aggregate airfoil profile, as shown by example in FIGS. 3-14. The blades 12 further comprised of a tip 14, a leading edge 16, a trailing edge 18 that is spaced from the leading edge 16, a blade center line 20, an upper surface 22 that extends from the leading edge 16 to the trailing edge 18 and across the tip 14 to the blade center line 20, and a lower surface 24 that also extends from the leading edge 16 to the trailing edge 18 and across the tip 14 to the blade center line 20. The HAWT 10 blade diameter is at least 3 feet (0.91 meters).

Each of the blades 12 is divided sequentially and longitudinally into a root section 28, an inboard section 30 and an outboard section 32. To complete the structure of the HAWT 10, a hub 46 connects at least two blades. The hub 46 has means for being attached to a rotating shaft, such as located on an electric motor or a gearing system. The attachment means is well known in the prior art and therefore is not disclosed herein.

The parameters that define an airfoil profile 26 of the instant invention, are shown in FIG. 3 and include: a pointed leading edge 16, a pointed trailing edge 18, an upper surface 22, a lower surface 24, and a chord line 52. FIG. 3 also shows the wind direction 50, the relative wind direction 51, the blade direction 58, and the plane of rotation 60 as a reference point for profile orientation.

The root section 28 is comprised of family A profiles, as exemplified in FIGS. 3-6, at selected chord locations. The inboard section 30 and outboard section 32 are comprised of family B profiles, as exemplified in FIGS. 7-12, at selected chord locations. FIG. 12 also exemplifies a profile used for the entirety of the outboard section 32, whereupon the chord size, the chord thickness and chord angles change, as shown in the parameter chart infra. The blade tip 14 is curved to the radius in the platform to reduce tip turbulence. Such a curve reduces high and low pressure points at the tip 14, which helps reduce tip drag and noise.

As also shown in FIG. 1, the root section 28 comprises 25% of the blade's length and the inboard and the outboard sections 30 and 32 each comprise 37.5% of the blade's length. The lower surface 24 of each family of profiles is greater than the upper surface 22, thereby creating a lift based on pressure differential according to Bernoulli's principle. Additionally, where family B profiles are used, the concave upper surface increases the pressure differential The pointed leading edge 16, as shown in FIG. 3, creates a localized vortex 54 under the blade's leading edge 16. This low pressure further improves the blade's lift to drag ratios, thus providing a broader power coefficient curve over a larger band of wind velocities then contemporary blades. This results in greater annual energy production as computed using the Weibull or Rayleigh distribution for a wind farm. The combination of a cambered lower surface 24 and the vortex 54 produces optimum performance in the wind velocity range of 5 mph (2.2 m/s) to 35 mph (15.65 m/s). The blades 12 can be fabricated of solid material for smaller blade diameters of up to 7.5 feet (2-3 meters). Hollow blades are fabricated for larger blade diameters.

The novel airfoil profiles of the instant invention gradually change longitudinally, in shape, size and in angle relative to the plane of rotation, thus giving varying aerodynamic characteristics along the blade for optimum performance.

A gradual augmentation of the pressure differential between the upper and lower surfaces of the airfoil profiles is accomplished by utilizing an increasing concave depth of the upper surface of the family B profiles, in the inboard and outboard sections of the blade, which combine with exponentially decreasing blade chord angles and a high twist. The combination causes the blade to operate at higher efficiencies, with a broader power coefficient against wind velocity compared to contemporary blades. The blade twist as shown in the Parameter Relationships Graph, is a combination of chord angles that exponentially increase in the root section and then exponentially decrease in the inboard and outboard sections, toward the blade tip. However, exponentially decreasing chord angles may be used throughout the blade.

In order to protect the surfaces of the blade as well as minimize the surface coefficient of friction, erosion and corrosion and reduce sensitivity to roughness, at least the leading edge is coated with protective material. The protective material includes gloss paint, resin-based material, fluoropolymers, thermoplastic resin or Teflon™, to provide effective erosion control for the leading edge of the wind turbine, with several other approaches and products also available. For instance, anti-erosion strips bonded to the leading edge may be used. Examples of anti-erosion strips are a polymeric tape or a polymeric coating onto a metal leading edge strip. Examples of metals of the strip are nickel and titanium (1 mm thick). Nickel-steel erosion strips can also be used. There are scratch resistant paints as well as 3M™ Wind Tape 8608, 8609 and Blade Tape 8671 (polyurethane protective tapes), specially designed for this purpose. There is also PropGuard™, which is an FAA approved anti-abrasion product, AeroKret™ coating for general protection of blades and CeRam-Kote™ family of high performance industrial coating products. Most of these products are designed to protect high-performance helicopter blade leading edges, which is far more demanding than protecting windmill blades. The degree of robustness of the erosion and corrosion control depends on the environment the turbine is used in. For instance, where much rain is expected, a stronger protective material would be used to protect the blades, particularly the leading edge.

Each profile has sharp leading and trailing edges. A sharp leading edge helps in deflecting particulate matter, insects and airborne contaminates due to the airflow and the vortex produced, thus reducing roughness. This feature, together with the airfoil profiles of the instant invention which are largely insensitive to roughness, along with the application of the protective coatings which have low surface coefficient of friction, minimize overall blade sensitivity to roughness.

The blade tip is curved to the radius of its rotation in the planform, which reduces drag and noise at the tip. The drag is typically caused by turbulence that is generated due to points of high and low pressure on the tip of a rotating blade when the tip is not curved to its radius of rotation.

The HAWT's coning angle ranges from 0° to 5°.

The operation of the instant invention is based on two means for achieving lift: the use of Bernoulli's principle and the use of a vortex. Contemporary blade utilizes a single means, which is Bernoulli's principle, to create lift. In the instant invention, Bernoulli's principle is utilized at the rear of the airfoil's lower surface 24, as shown in FIG. 3. The arrow indicates the blade direction 58 and 60 represents the plane of the blade's rotation. The chord line 52 shows the blade angle relative to the plane of rotation 60. A low-pressure zone is created at the lower surface 24 of the airfoil profile, toward the trailing edge 18 in the vicinity of a camber 56, which provides one of the two lift vectors for the blade. The second lift vector is provided at the front of the lower surface 24 of the profile 26 due to the blade's sharp leading edge, which provides a low-pressure zone in the form of a vortex 54. This combination of two forms of creating lift is more effective than just the use of Bernoulli's principle. A further lift improvement is achieved through the increase in the pressure differential between the upper surface 22 and the lower surface 24 of the inboard and outboard sections of the blade by the use of an increasing concave curvature 44 of the upper surface 22, in the family B profiles, as shown in the example of FIG. 12.

The family A and B profiles of the preferred embodiment are designed for Reynolds numbers of at least 1,000,000.

The Parameter Relationships Graph shown supra illustrates a chord angle graph z of the preferred embodiment, relative to a blade radius, with a range as given in the Parameter Chart given supra. The c/R ratios given apply only to the outboard section of the blade where c is averaged for this section and c/R=0.314 for the preferred embodiment. All chords may have the same length in this section. The graph illustrates only parametric relationships and proportionalities to specific chord angles. In the preferred embodiment, the blade radius termination at the tip is at 10° for outboard section's value of c/R at 0.314, as illustrated by graph z. Furthermore, the Parameter Chart gives relative values and ranges applicable to the preferred embodiment. The chord lengths and other parameters for the rest of the blade sections are derived from the parameter relationships in the Parameter Chart.

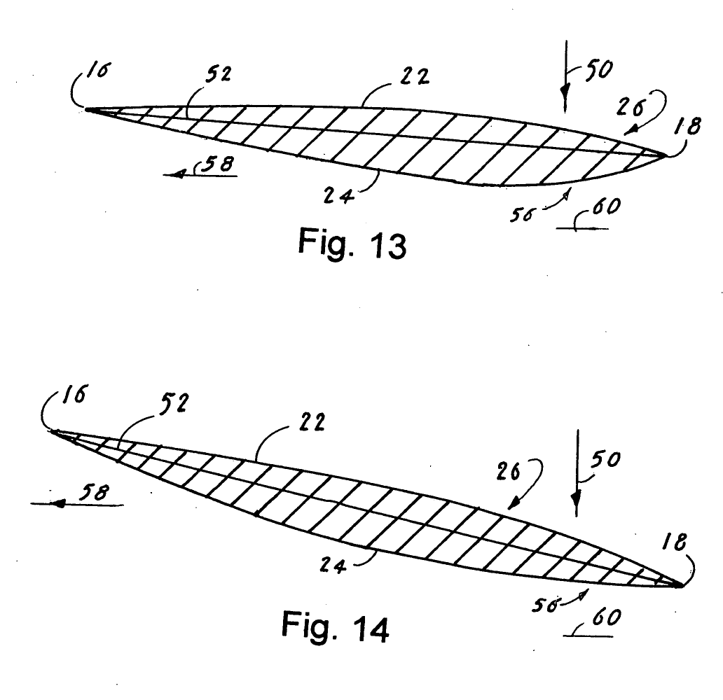

In a second embodiment, family C profiles, an example of which is shown in FIG. 13, is used to replace profiles, at least in one section of the blade.

In a third embodiment, family D profiles, an example of which is shown in FIG. 14, is used to replace profiles, at least in one section of the blade.

While the invention has been described in detail and pictorially shown in the accompany drawings it is not to be limited to such details, since many changes and modifications may be made to the invention without departing from the spirit and the scope thereof. Hence, it is described to cover any and all modifications and forms, which may come within the language and scope of the claims.

1. A horizontal axis wind turbine (HAWT) comprising:
a) at least two identical blades, wherein each said blade comprises:
(1) a tip,
(2) a sharp leading edge
(3) a sharp trailing edge that is spaced from the leading edge,
(4) a blade center line,
(5) an upper surface that extends from the leading edge to the trailing edge and across the tip to the blade center line,
(6) a lower surface that extends from the leading edge to the trailing edge and across the tip to the blade center line,
(7) an aggregate of airfoil profiles, and
b) a hub that is attached to a rotatable shaft.

2. The HAWT as specified in claim 1 wherein each said blade is divided sequentially and longitudinally into a root section that extends from the blade center line, an inboard section and an outboard section that terminates at the tip of said blade, wherein the sections, in combination, encompass said airfoil profiles.

3. The HAWT as specified in claim 2 wherein the root section is comprised of family A profiles for Reynolds numbers of at least 1,000,000.

4. The HAWT as specified in claim 2 wherein the inboard section is comprised of family B profiles for Reynolds numbers of at least 1,000,000.

5. The HAWT as specified in claim 2 wherein the outboard section is comprised of family B profiles for Reynolds numbers of at least 1,000,000.

6. The HAWT as specified in claim 2 wherein at least one section of the blade is comprised of family C profiles.

7. The HAWT as specified in claim 2 wherein at least one section of the blade is comprised of family D profiles.

8. The HAWT as specified in claim 2 wherein the radius of the root section is 25% of the radius of said blade.

9. The HAWT as specified in claim 2 wherein the inboard section sequentially follows the root section and covers the next 37.5% of the radius of said blade.

10. The HAWT as specified in claim 2 wherein the outboard section, which includes the tip, sequentially follows the inboard section and covers the remaining 37.5% of the radius of said blade, wherein the ratio of the chord length, c, and the blade radius, R, is given as c/R, wherein the outboard section ratio of c/R≦0.33 with a preferred c/R ratio of 0.314 and where c is averaged for this section.

11. The HAWT as specified in claim 10 wherein said outboard section comprises of equal chord lengths.

12. The HAWT as specified in claim 1 wherein each airfoil profile comprises:
a) a sharp leading edge,
b) a sharp trailing edge,
c) an upper surface,
d) a lower surface, and
e) a chord line.

13. The HAWT as specified in claim 12 wherein the lower surface of each airfoil profile is greater in length than the length of the upper surface.

14. The HAWT as specified in claim 1 further comprising airfoil profiles that gradually change longitudinally, in shape, size and in angle relative to the plane of rotation, according to the Parameter Chart and the Parameter Relationships Graph, wherein the airfoil profiles produce varying aerodynamic characteristics along said blade for optimum performance.

15. The HAWT as specified in claim 1 wherein said HAWT utilizes a combination of Bernoulli's principle by the application of a large camber at the lower surface of said airfoil profile toward the trailing edge compared to the upper surface, in addition to utilizing a vortex at the lower surface of said profile toward the leading edge by the inclusion of a sharp leading edge to said profile.

16. The HAWT as specified in claim 1 further comprising a gradual augmentation of a pressure differential between the upper and lower surfaces of said airfoil profile, wherein the gradual augmentation is produced by utilizing an increasing concave depth of the upper surface of the airfoil profiles from the end of the root section of each said blade to its tip.

17. The HAWT as specified in claim 1 wherein said blade has a twist.

18. The HAWT as specified in claim 17 wherein said blade's twist is exponential.

19. The HAWT as specified in claim 17 wherein said blade has a high twist angle.

20. The HAWT as specified in claim 18 wherein the exponential twist conforms to the z graph in a Parameter Relationships Graph, wherein the z graph's range is +5 degrees to −10 degrees and wherein the chord angles of the root section increase.

21. The HAWT as specified in claim 17 wherein said blade's entire twist comprises reducing angles to its tip.

22. The HAWT as specified in claim 1 wherein at least the leading edge of said blade is applied a protective material that is selected from the group consisting of gloss paint, scratch resistant paint, resin-based material, fluoropolymers, thermoplastic resin, Teflon™, polymeric tape, polymeric coating, anti-erosion strips, nickel-titanium strips, nickel-steel erosion strips, polyurethane protective tapes, 3M™ wind tapes 8608, 8609 and blade tape 8671, PropGuard™, AeroKret™ and CeRam-Kote™ family of high performance industrial coating products.

23. The HAWT as specified in claim 1 wherein said blade tip is curved to its radius of rotation.

24. The HAWT as specified in claim 1 further comprising a coning angle having a range from 0° to 5°.

25. The HAWT as specified in claim 1 further comprising a Parameter Relationships graph that shows data pertaining to relationships of specific airfoil chord angles to blade radius proportionalities and c/R ratios through blade tip termination points.

26. The HAWT as specified in claim 1 further comprising a parameter chart that shows data pertaining to parameter relationships and proportionalities applicable to all blade variations.

27. The HAWT as specified in claim 1 wherein variations of parameters of said blade are comprised of the ranges of parameters shown in the Parameter Relationships Graph and the Parameter Chart.

28. The HAWT as specified in claim 1 further comprising a plurality of formulas:
a) for parametric extrapolations, c/R=0.22/x, where x is the quantity along the x-axis of the Parameter Relationships Graph,
b) for chord size range, c/R≦0.33 and
c) for the preferred embodiment, c/R=0.314.

29. The HAWT as specified in claim 1 wherein said aggregate of airfoil profiles are substantially represented in FIGS. 3, 4, 5, 6, 7, 8, 9, 10, 11, 12, 13 and 14.

30. The HAWT as specified in claim 1 wherein said blade has a planform substantially represented in FIG. 1.
